(19) United States
(12) Patent Application Publication
(10) Pub. No.: US 2006/0045659 A1
(43) Pub. Date: Mar. 2, 2006

(54) Buffered magazine method and system for loading and unloading ships

(76) Inventor: William B. Hubbard SR., Sequim, WA (US)

Correspondence Address: Everitt Beers;McNichols Randick O'Dea & Tooliatos, LLP, Suite 400, 5000 Hopyard Road, Pleasanton, CA, 94588, US

(21) Appl. No.: 10/911,857

(22) Filed: Aug. 4, 2004

(51) Int. Cl. B65G 67/60

(52) U.S. Cl. 414/139.4

(57) ABSTRACT

An buffered marine magazine terminal method provides for the discharge of import containers from a container ship to well cars, in the simultaneous discharge of export containers from well cars to an ITZ. Once the container ship is sufficiently unloaded, export containers from the ITZ may be loaded onto the container ship using a double-buffered magazine method and system. Simultaneously, the ship may be discharged of further import containers. The method also provides for reworking of well cars at a remote rail buffer and classification yard, in communication between the intermodal interface center and the remote rail buffer and classification yard via a dedicated freight corridor. A data management system manages the intermodal exchange of containers between ship, rail, and truck utilizing a common user electronic data management system.

### 1. BACKGROUND OF THE INVENTION

a. Field of the Invention

The invention concerns a method and system for efficiently interfacing containerized marine and rail cargo loading and discharging. More specifically, the invention concerns the method and system for the integrated simultaneous load and discharge of a container ship and a stack train using a double-buffered magazine terminal to increase efficiency.

b. Description of the Related Art

Traditionally, general cargo for ships has been assembled at the port of loading before the arrival of the vessel. Cargo either was accumulated along the side of the vessel or was stored in warehouses. This was done to ensure that cargo with the proper attributes was immediately available to load the vessel to prevent or minimize any delay to the vessel. Delay to the vessel is arguably the most expensive component of a cargo transportation system.

Cargo discharged from the vessel was also held in the port area adjacent to the vessel, until arrangements for delivery or on-carriage could be made.

Several points must be considered when accumulating cargo. Each ship must be loaded and discharged observing a precise protocol. Cargo must be loaded so as to be forwarded to the correct port. Moreover, a vessel must be loaded and weighted properly, and cargo must be stored in the proper locations. For example, flammable cargo has special requirements. Therefore, vessel stability, port of discharge, special cargo requirements such as temperature control, dangerous and hazardous material regulations, shipper's special requirements, and other considerations must all be met.

Before the development of the containerized shipping system, the cargo was simply held on the pier or in the warehouse adjacent to the pier.

Containerized shipping was a large improvement over previous systems. When container ships were small, traditional methods still worked.

However, as ship capacity grew, the warehouses or sheds disappeared and the containers were marshaled in large parking lots near the pier waiting for the ship's arrival. In the case of inbound cargo, the containers in the parking lots were waiting for delivery or on-carriage arrangements to be accomplished.

Parking lots are cheaper and easier to develop than covered sheds. Initially, this was considered one of the great benefits to be obtained from the containerized shipping system. However, as the capacity of container ships increased from about 400 twenty-foot equivalent units (TEU's) to over 6,000 TEU's in the span of 40 years, the size of the area required to accommodate storage of the containers dramatically increased. Whereas 50 acres was once adequate capacity for a shipping terminal, terminals of more than 400 acres are currently in use.

The disadvantage of these large terminals is that land available in port areas is scarce and very expensive. In addition to the scarcity and expense of the resources, the ability to develop available land has become suspect. Environmental concerns virtually preclude significant reclamation from wetlands in the future, thus threatening the ability to develop the available port area land for adequate storage capacity.

Exacerbating the problem is the fact that existing facilities are nearly at capacity in many areas; some approaching gridlock. Growth of international trade, especially with China and Asia, continues to grow at expected double-digit rates. Many federal and local agencies have studied the approaching port gridlock. Despite the impending need, no working solutions have been discovered. Impacted or constrained ports will have a significant negative effect on local, national, and world economies.

Additionally congested ports affect national security and the military's ability to respond to international events.

There have been many attempts to solve the port congestion problem. Typically, these attempts envision a scheme for the vertical stacking of the containers to make more efficient use of available marine terminal land. In these schemes, large parking lots at the point at the port are required to assemble the appropriate inventory of containers, so that a sufficient selection of containers with the desirable attributes are available to ensure a proper stow to the ship or train. Generally, containers just discharged from either the ship or train must be held in this location until arrangements can be made for delivery or on-carriage.

These more traditional methods and devices for use therewith are shown, for example in U.S. Pat. No. 3,631,993, which discloses a containerized cargo storage and handling system. It includes a storage facility for temporarily storing containers which are being exchanged between a ship and trucks and trains. U.S. Pat. Nos. 3,700,128 and 3,952,891 disclose intermodal transfer systems for exchanging goods between ships and land or air vehicles. U.S. Pat. No. 4,973,219 discloses a high density container storage yard used in exchanging goods between transport ships and rail cars. U.S. Pat. Nos. 4,090,620, 4,293,077 and 4,872,798 all disclose varieties of transfer apparatus for directly conducting goods between ships and rail vehicles.

All of the above fail to solve the problem experienced in existing facilities. Namely, they fail to address the scarcity of port-adjacent land and the speed with which containers are operationally handled. The scarce port land must be used more efficiently. For example, vertical stacking of containers may use land more efficiently, but decreases operational efficiency in terms of cost and velocity.

The U.S. Pat. No. 5,505,585, by the same inventor, has addressed some of these problems by reducing the need for port-side land and increasing cargo velocity. However, inefficiencies remained in that velocity was negatively affected by the need to handle containers multiple times and the logistical problems caused by the need to swap out trains loaded with inbound cargo for trains loaded with outbound cargo without negatively impacting the total operation. Thus, there remains a need for a method to more efficiently utilize existing limited land in port areas while at the same time further decreasing cost and increasing cargo velocity.

### 2. SUMMARY OF THE INVENTION

The object of the invention in its preferred embodiment is to handle each container once from the train to the ship and from the ship to the train. In this preferred embodiment, minimal storage land is needed at the port.

In all embodiments, the invention minimizes the need for the use of port-adjacent land and increases the velocity of cargo.

An additional benefit of the invention is to permit relocation of facilities from the port of loading to areas where there is a more land available. At the same time, the invention provides the benefit of accommodating the use of small areas of land at shipside without loosing the ability to meet the stowage requirements of both ship and train.

Another benefit of the invention is to provide a more efficient method to assemble an inventory of containers to properly stow both a vessel and a train.

Another benefit of the invention is scalability. It allows more efficient use of existing facilities for both current vessel and train capacity as well as anticipated future increased vessel and train capacity, all with minimal or no impact on the terminal.

Another benefit of the invention is increased efficiency in the use of container handling equipment in reducing or eliminating idle time.

Another advantage of the present invention is that it utilizes a method of integrating the simultaneous load and discharge of a container ship with the simultaneous load and discharge of a stack train. In the preferred embodiment, the simultaneous load and discharge of both vessel and train are maximized.

Another advantage of the invention is that it permits cargo storage areas to be moved away from the ship and relocated to an area where land is more available.

Another advantage of the invention is that it permits the interfacing of vessels and rail cars with a high degree of timing and reliability.

Another advantage of the invention is that it minimizes or eliminates local traffic problems and residents' objections associated with port related traffic.

Another advantage of the invention is that trains could originate and terminate at the port complex with little impact upon the actual port area by being handled through a central corridor, possibly grade separated. Additional benefits could be achieved by electrification of the corridor which would help reduce air and noise pollution from the trains.

Another advantage of the invention is to provide a more robust integrated and planned way to interface trains and vessels. The invention would permit an inland Intermodal Interface Center (“IIC”) to become a terminus for carriers serving the export trade. Trains and trucks arriving from the interior with containers for multiple ocean carriers could be unloaded at the inland IIC, and the containers stored until required for loading by an ocean carrier. Trains and trucks would be loaded with cargo destined for inland locations from the inventory of import containers assembled from the containers shuttled from multiple ocean carriers and terminals.

Another advantage of the invention is that it permits the IIC to serve as an assembly and distribution point for local container traffic, for both international and domestic cargo. As a result, international cargo destined for the local market could be shuttled from the ship to the inland IIC and then delivered to the local market. Similarly, the same benefit holds true for containers of international destination that originated locally. These advantages likewise hold true for cargo destined only for the rail system. That is, cargo originating in the rail system destined for local delivery would be discharged from the originating trains and then delivered from the inland IIC. Containers with domestic cargo destined for interior points could be also be staged at the inland IIC and integrated with international cargo, likewise destined for interior points.

In one embodiment, the invention provides a method and system of exchanging export and import containers between a container ship and rail cars. A simple embodiment uses one crane and two magazines. A first magazine is charged with a train segment containing export loads with enough empty spaces to accommodate the discharge of the largest cell in the hatch being unloaded. The containers of that largest cell of a hatch are then unloaded to the empty well cars. This allows the commencement of a simultaneous load and discharge operation between ship and train, which then continues until the last cell of the hatch is discharged, where the final loads from the train are loaded one-way.

When all of the rail cars in the magazine have been filled with import loads, the operation switches to the second magazine, where a train filled with export loads is already located. While the second magazine is worked, the first magazine is recharged. Recharging a magazine means rail cars loaded with import cargo are switched out and rail cars loaded with export cargo are switched in. The switching out a loaded rail car refers to the removal of the rail car to a storage yard or IIC for unloading of import containers and loading of export containers. Switching in of rail cars refers to moving rail cars loaded with export containers from a storage yard or IIC to the magazine. The simultaneous load and discharge operation continues with the second magazine.

The magazines are alternately emptied and recharged until the vessel has been fully discharged and reloaded.

In another embodiment of the invention, a magazine is charged with well cars all loaded with export containers. A number of containers approximately equal to the number of containers that must be discharged to permit a simultaneous load and discharge operation between ship and train to commence are removed and placed in the magazine's intermodal transition zone (“ITZ”). Once these rail cars have been cleared, they are loaded with import containers in a one-way operation. Then a simultaneous load and discharge operation commences which continues until the last import load has been discharged from the hatch. Then a one-way load operation commences until the last export container has been loaded.

The magazines are alternately emptied and recharged until the vessel has been fully discharged and reloaded.

### 3. BRIEF DESCRIPTION OF THE DRAWINGS

### a. Drawing Contest Descriptions

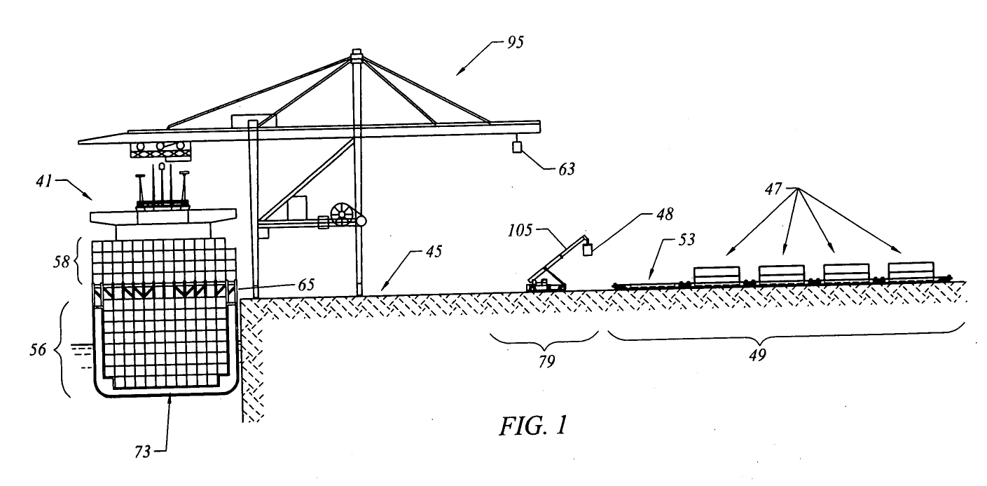

FIG. 1 is a cross-sectional view of a container ship and rail magazine showing the beginning of the unloading operation with all cells and deck storage on the container ship filled.

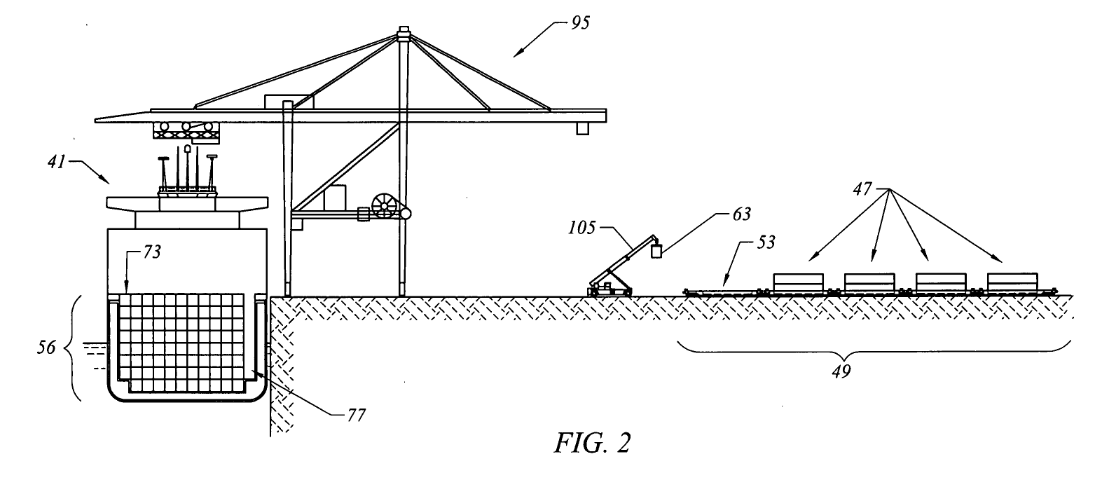

FIG. 2 is a cross-sectional view of a container ship and rail magazine showing the unloading operation at the stage where all deck storage has been unloaded and the first vertical cell on the ship has been cleared.

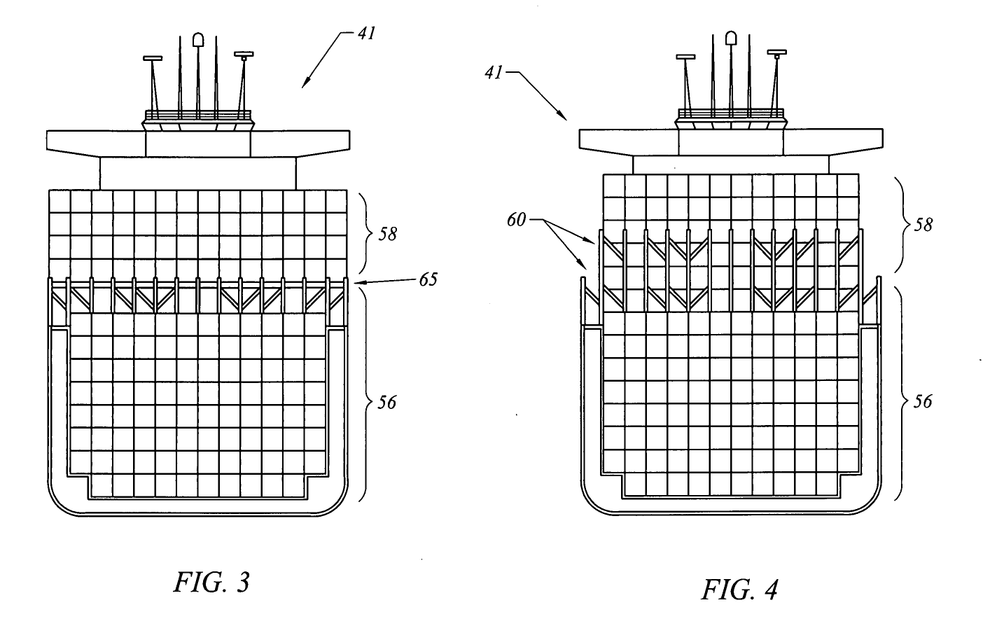

FIG. 3 shows an end cross-section of a standard container ship with covered hatches and above deck storage placed upon the hatch covers.

FIG. 4 shows an end cross-section of a container ship that does not use hatch covers.

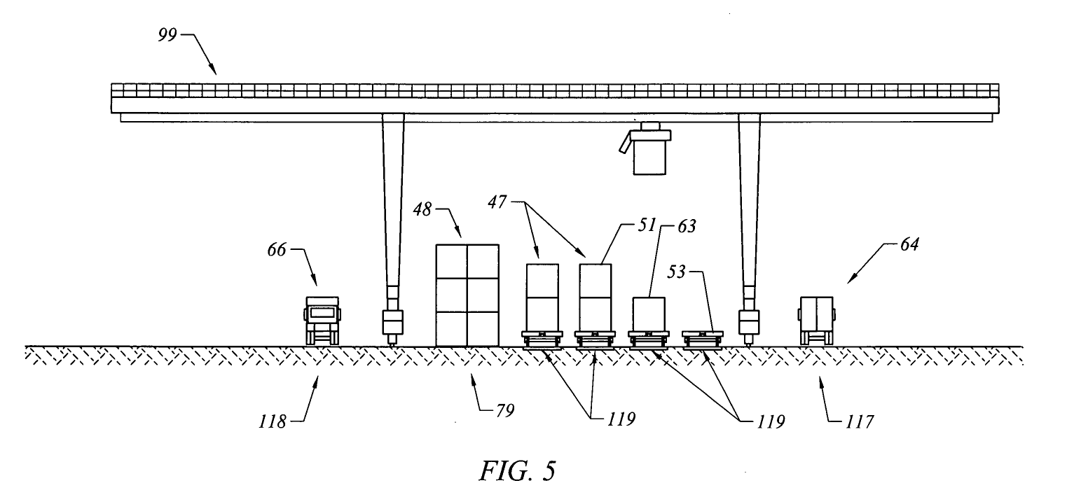

FIG. 5 shows an end cross-section of a rail magazine using a rail-mounted gantry crane.

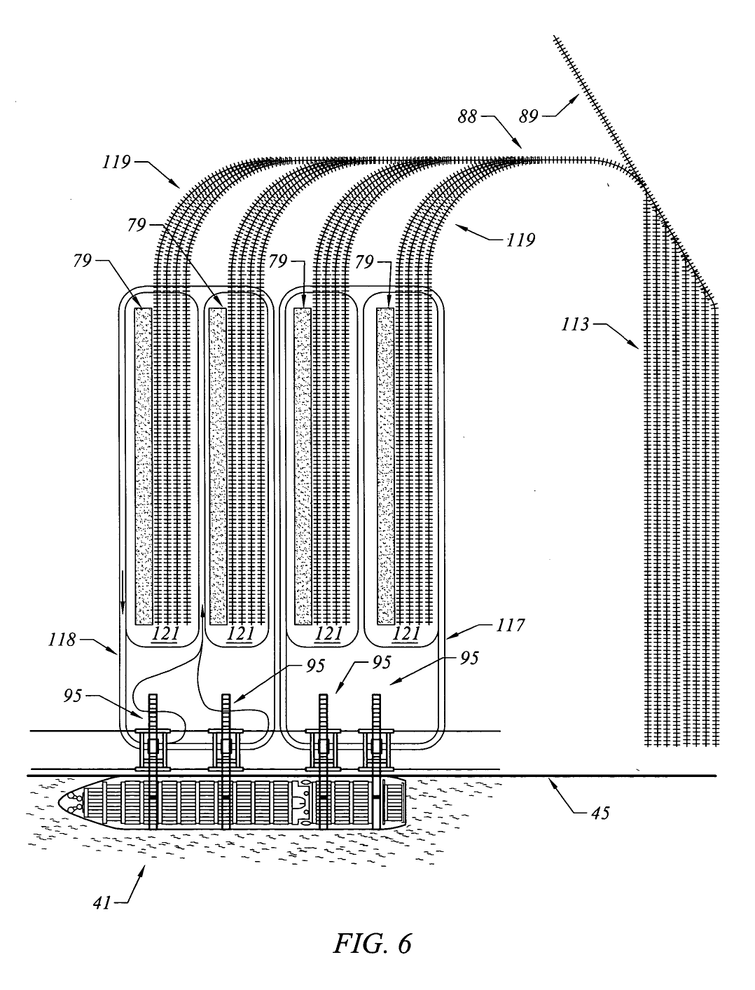

FIG. 6 shows an overhead plan view of a Buffered Marine Magazine Terminal (“BMMT”) consisting of four magazines and a corridor connecting to a Remote Rail Buffer and Classification Yard (“RRBCY”).

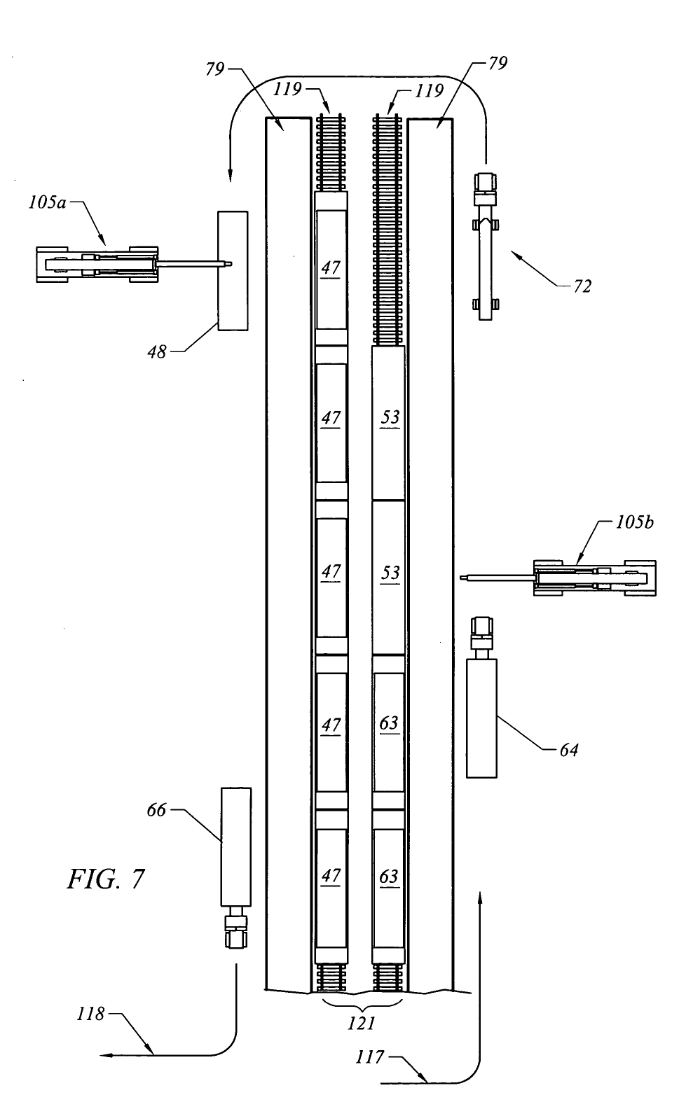

FIG. 7 shows an overhead plan view of a two-track rail magazine with reach stackers and ground transports.

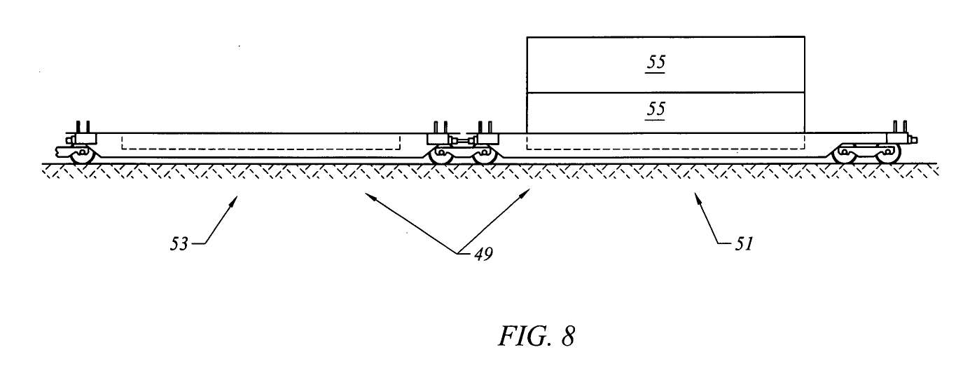

FIG. 8 shows well cars with one rail car loaded with two containers.

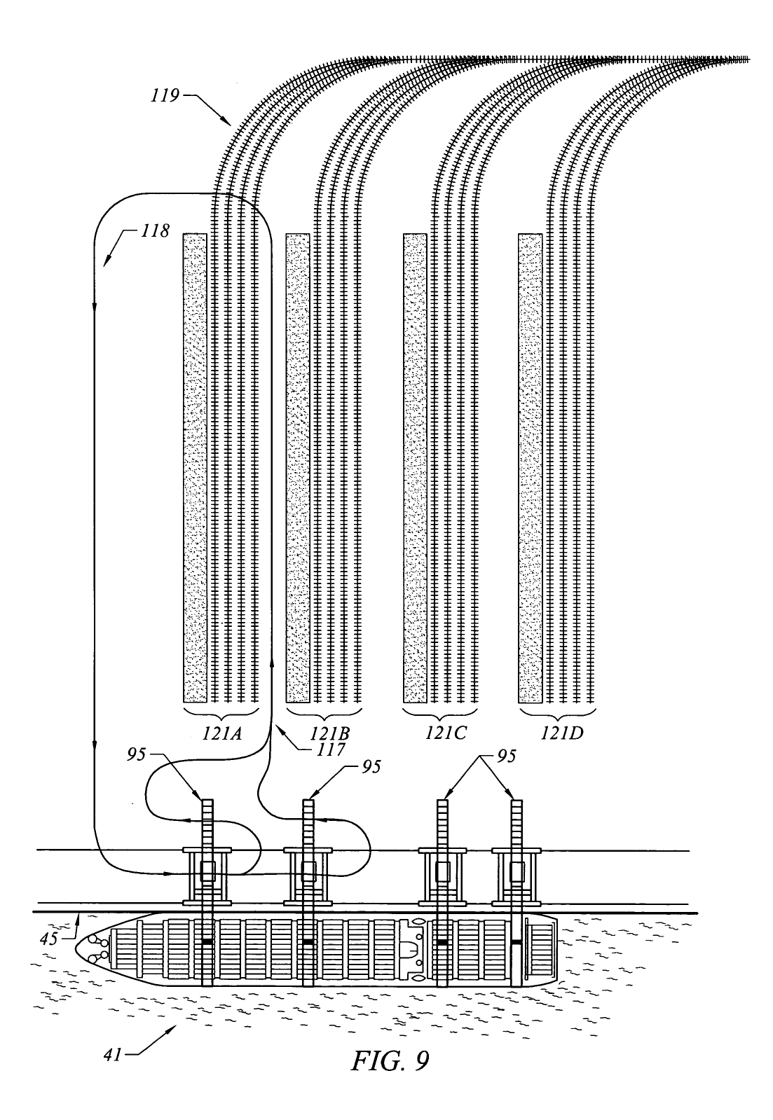

FIG. 9 shows an overhead plan view of a BMMT consisting of four magazines including sample ground transport paths to and from a container ship with two cranes working the first magazine.

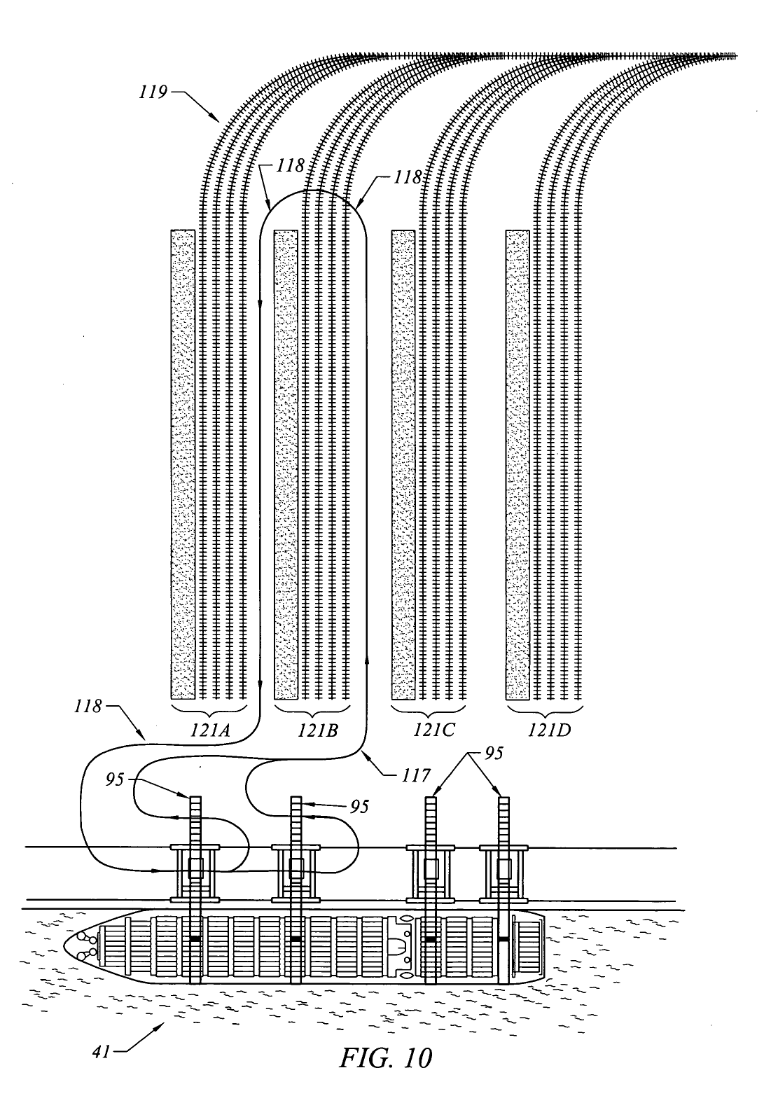

FIG. 10 shows an overhead plan view of a BMMT consisting of four magazines including ground transport paths to and from a container ship with two cranes working the second magazine.

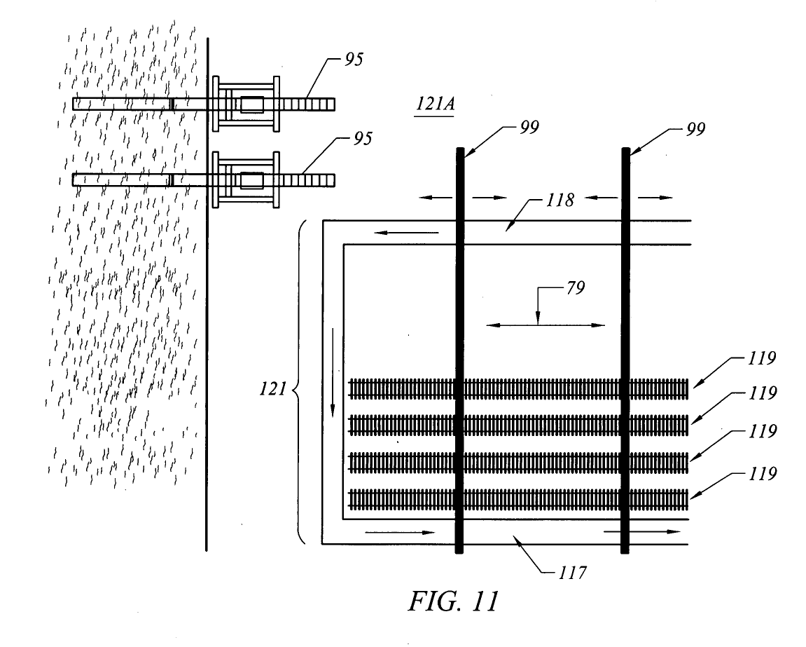

FIG. 11 shows schematically the layout of a four-track rail magazine including truck lanes.

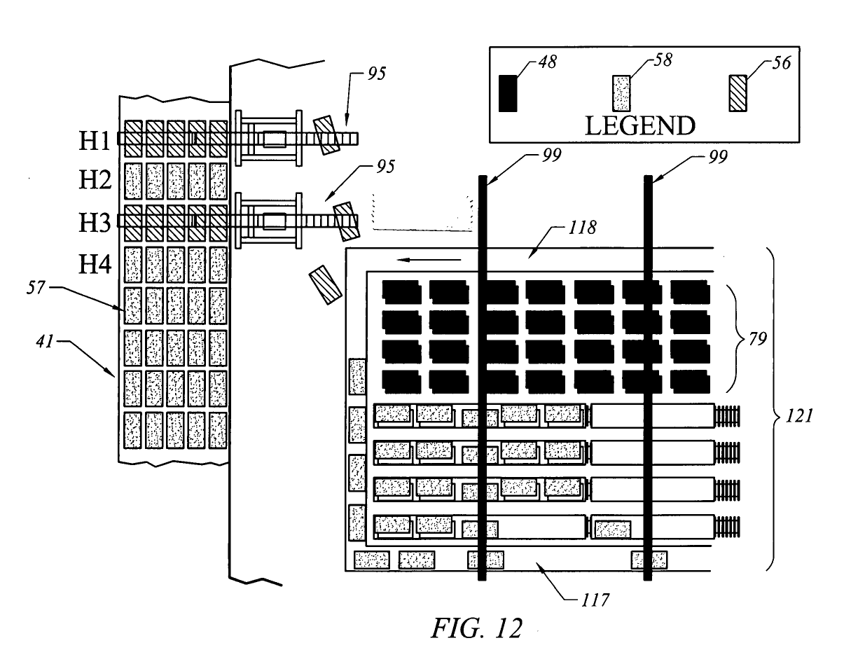

FIG. 12 schematically shows a rail magazine at the stage in an unloading process where the above deck stow has been cleared for two hatches.

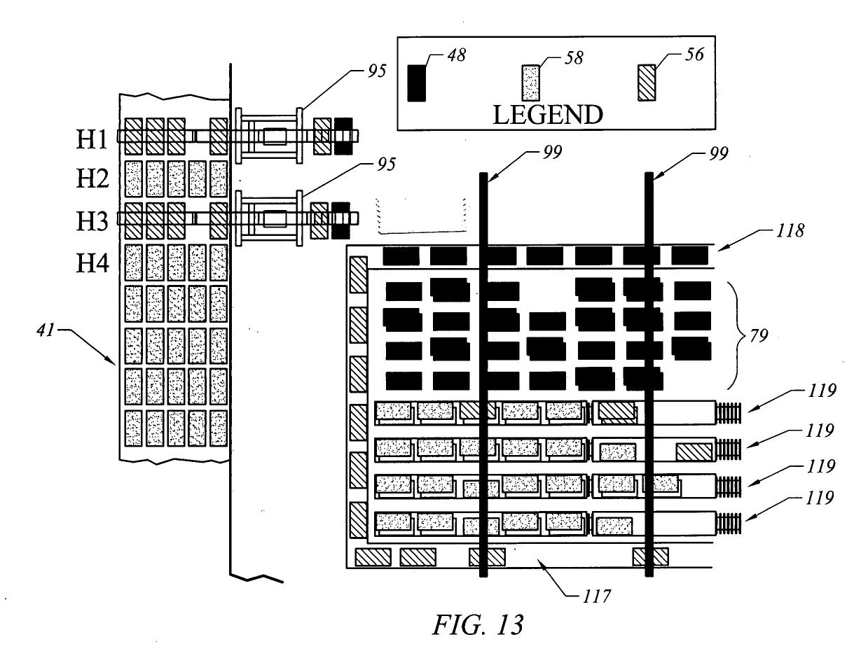

FIG. 13 schematically shows a rail magazine where a simultaneous load and discharge operation is being performed.

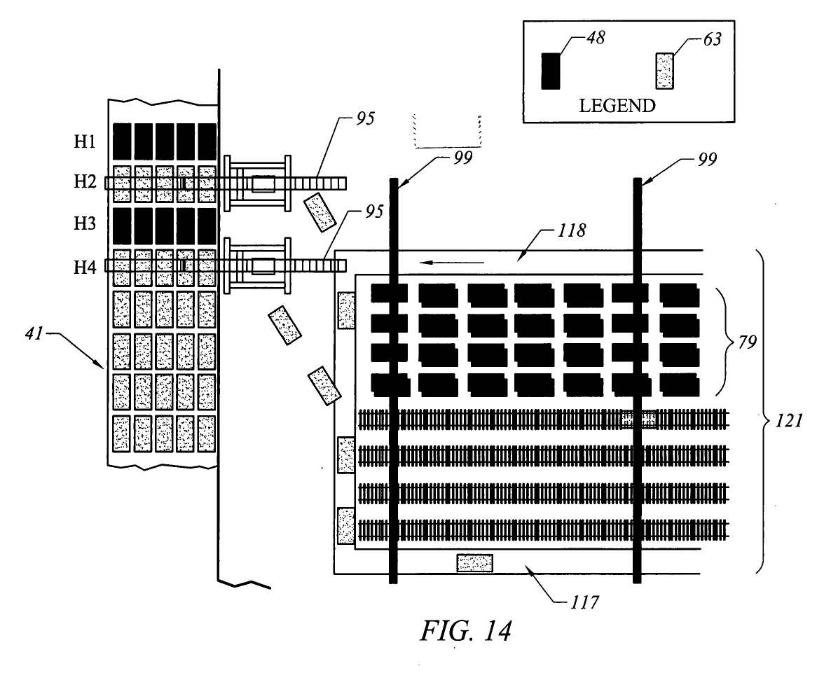

FIG. 14 schematically shows a rail magazine at a stage in the operations where the ship cranes have been moved to a new pair of hatches to repeat the loading and unloading operations.

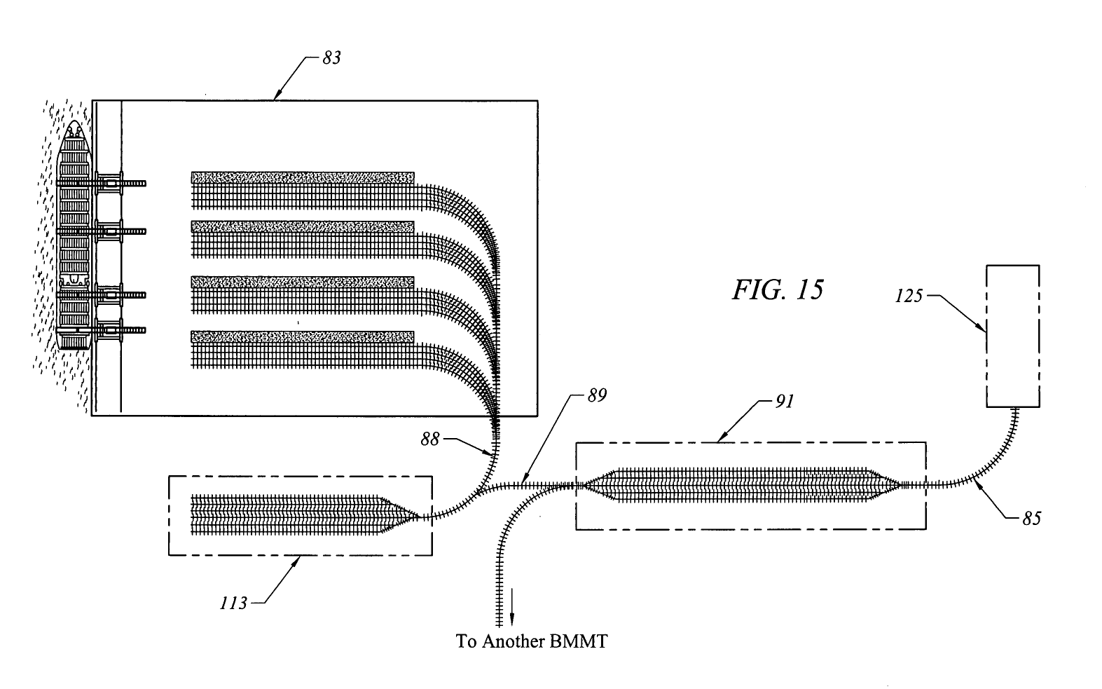

FIG. 15 schematically shows an entire Buffered Marine Terminal Agile Port System including a BMMR, a RRBCY, a Dedicated Freight Corridor (“DFC”), and an IIC, which connects to the Intermodal World of transportation (highway, maritime, rail, and air).

b. Drawing Key

| Number | Description | As shown in |
|---|---|---|
| 41 | Container ship | FIG. # 1 |
| 45 | Pier | FIG. #1 |
| 47 | Export containers on well car | FIG. # 1 |
| 48 | Export containers in ITZ | FIG. # 1 |
| 49 | Well cars | FIG. #1 |
| 51 | Well cars 2 containers high | FIG. # 8 |
| 53 | Well cars empty | FIG. #8 |
| 55 | Containers | FIG. # 8 |
| 56 | Containers below hatch covers | FIG. # 1 |
| 58 | Containers above hatch covers | FIG. # 1 |
| 60 | Buttressing system | FIG. # 4 |
| 63 | Import container | FIG. # 1 |
| 64 | Import load on bomb cart with tractor | FIG. # 7 |
| 65 | Hatch covers | FIG. # 1 |
| 66 | Export load on bomb cart with tractor | FIG. # 7 |
| 72 | Empty bomb cart with tractor | FIG. # 7 |
| 73 | Vertical cell in hatch | FIG. # 1 |
| 77 | Cleared vertical cell | FIG. # 2 |
| 79 | Intermodal transition zone ITZ | FIG. # 6 |
| 83 | Buffered Marine Magazine Terminal BMMT | FIG. # 6 |
| 85 | Access to Intermodal World | FIG. # 15 |
| 88 | Access to magazines | FIG. # 15 |
| 89 | Dedicated Freight Corridor (DFC) | FIG. # 15 |
| 91 | Intermodal Interface Center IFC | FIG. # 15 |
| 95 | Ship Gantry Container Crane | FIG. # 1 |
| 97 | Mobile Lift | FIG. # 1 |
| 99 | Rail Mounted Gantry Crane | FIG. # 5 |
| 105 | Reach Stacker | FIG. # 1 |
| 113 | Rail Storage Buffer & Classification Yard | FIG. # 6 |
| 117 | Truck Lane to magazine from ship | FIG. # 5 |
| 118 | Truck Lane from magazine to ship | FIG. # 5 |
| 119 | Rail Tracks | FIG. # 6 |
| 121 | Magazine | FIG. # 6 |
| 123 | Tractor or Prime Mover | FIG. # 7 |
| 125 | The Intermodal World | FIG. # 15 |

### 4. DETAILED DESCRIPTION OF THE DRAWINGS

FIG. 1 illustrates an efficient marine/rail interface terminal at ship side. Illustrated in the figure is a cross section of a container ship 41, an import container being discharged 63, and a crane 95 (illustrated as a gantry crane) discharging the import container 63.

As the operation progresses, the import containers are moved to/from their destination areas by mobile equipment and lifts, such as bomb carts hauled by tractors 72, FIG. 7, and reach stackers 105, travelling to and from a rail magazine. The ship 41 is located next to a pier 45, near the rail magazine 121.

Illustrated in the rail magazine 121 are export containers 47 contained on well cars 49. FIG. 1 also includes a cross section of a container ship 41 and shows the relevant construction. On the container ship 41, there may be containers, 58 stowed on hatch covers 65. Also, there may be containers 56, stowed below deck. The container ship is equipped with vertical cells 73. The containers 56 and 58 meet conventional industry standards, including ISO standards. The container ships use these conventional standards. Although a container ship with hatch covers is illustrated, container ships without hatch covers also work with the invention (See FIG. 4).

In this stage of the illustrated embodiment, the container ship 41 is fully loaded with import containers 56, and 58, except for the import container 63 being discharged, which has been engaged by the crane 95. The first mobile lift (and in this example is configured as a reach stacker 105) will transport the container 63, once it has been deposited on the pier 45, to the rail magazine. Meanwhile, export containers 47 are unloaded from the well car 49 by a reach stacker 105. By the time a first import container 63 has been discharged to the pier 45 by the crane 95, picked-up by the reach stacker 105, and transported to the magazine, the well car 49 will have been unloaded of its export container 47.

At the beginning of the operation, the import containers are stored with the on-deck stow 58 (the containers stored on the hatch cover 65). As the operation progresses, all of the containers stored on the hatch cover 65 must be removed, and then the hatch covers and all of the containers in a particular vertical cell 73 must be removed creating an empty vertical cell 77 before any containers for export can be loaded into the container ship 41.

With large container ships 41 with hatch covers 65, this can be a total of as many as 105 containers or even more which must be discharged from the vessel hatch before any can be loaded back onto the vessel. (On ships without hatch covers, only the number of containers required to clear the vertical cell must be unloaded before beginning simultaneous loading and discharging.) According to the invention, as each import container is removed from the ship, it is taken directly to an empty well car 53 in a rail magazine. (Well cars are also known within the industry as “double stack cars”.)

The unloading and reloading of a hatch comprises the following steps:
a. one way off load until hatch covers clear.
b. remove the hatch covers.
c. one-way off load of first vertical cell below deck.
d. with a cleared vertical cell, an export load can be loaded and an import load from an adjoining cell discharged (simultaneous load and discharge operation)
e. one-way loading of the last cell below deck.
f. replacement of hatch covers.
g. one-way loading of containers above the hatch covers.

FIG. 2 illustrates a cross-section of a container ship 41 at a point in time when the on deck stow has been removed, the hatch covers removed, and several containers 56 in a vertical cell 73 have been removed, to create a cleared vertical cell 77. Each import container discharged from the vessel from the on deck stow and the cleared vertical cell 77 has been removed from the container ship 41 by the crane 95, placed onto the pier 45, picked up by the mobile lift 105, and loaded into one of the well cars 49. At the same time, export containers 47 are removed from the well cars 49 by a mobile lift 105 and placed in an ITZ 79. Containers are stored in the ITZ 79 in a manner so as to be accessible as required for loading onto the container ship 41.

Thus, at the same time that the container ship 41 is having import containers discharged, the well cars 49 loaded with containers 47 for export also commence unloading. However, unlike the container ship 41, only two containers 47 must be removed from each well car 49 before import containers can be loaded back to the well car 49. Therefore, by the time the first import containers 63 have been discharged from the ship and reach the magazine, an empty well car 49 will be available for the loading of those containers.

The containers 47 destined for export cannot be loaded onto the container ship 41 until the deck of the container ship 41 has been cleared of the on-deck stow the hatch covers removed, and one cleared vertical cell 77 is available. Until this condition is reached, the export containers are stored in the ITZ, which is in the magazine. Thereafter, export containers can be loaded simultaneously with the discharge of import containers.

FIG. 3 shows a cross section of a typical hatch on a container ship 41. In the container ship 41 illustrated, all of the vertical cells above and below the hatch covers 65 are filled with containers 58 and 56. This configuration would be typical of the container ship 41 on arrival, before the start of operations according to the invention, with all cells filled with import containers. This configuration would also be representative of the container ship 41 at the completion of operations according to the invention, when the container ship 41 is ready to depart with all cells filled with containers for export.

FIG. 4 illustrates a cross section of a container ship 41 without hatch covers. Although most of the examples of the discussed embodiments use a container ship that has hatches, embodiments of the invention can also utilize ships without hatch covers. In a ship without hatch covers, a buttress system 60 can be added for structural stability.

FIG. 5 is an end view of a magazine served by a rail-mounted gantry crane 99 that spans the magazine from the truck lane from the ship 117, rail lines 119, the ITZ 79 and the truck lane leading back to the ship 118. Export containers on well cars 47, 51 are removed to create empty well cars 53 and placed in the ITZ 79. The gantry removes import containers 63, 64 to place in well cars 53. When simultaneous load and discharge (“SLD”) commences, the gantry loads export containers 47 and 48 to empty bomb carts with tractors 66 in truck lane 118 to go to the ship 41. The operation continues as each import load is lifted from a bomb cart 64 and stowed in a well car 53 creating an empty bomb cart which proceeds to be loaded with an export load for the ship 41.

FIG. 6 is a plan view of an BMMT with ship 41 at pier 45, four container cranes 95 four magazines 121 with four rail lines 119 serving each magazine. Each magazine has an ITZ 79 and each magazine is served by truck lanes from the ship to the magazine 117 and truck lanes returning to the ship 118. All rail lines converge into a magazine to buffer corridor 88 leading to a RRBCY 113.

FIG. 7 is a plan view of an embodiment using a two-track magazine 121 with two ITZ 79 adjacent to two rail tracks 119 served by two reach stackers 105 and tractors with bomb carts 72 transporting import loads 64 from the ship to the magazine 121 along the truck lane 117. One reach stacker 105a is removing export loads from the well cars and placing them either in the ITZ 79 or onto empty bomb carts 71 in a SLD operation to return the export load on a bomb cart with tractor 66 to the ship in truck lane 118. Reach stacker 105b is loading import loads 63 to the empty well cars 53 created by reach stacker 105a. When all of the export loads 47 have been removed, the empty well cars 53 will be filled with import loads. The operation will then shift to a second magazine. The first magazine will be recharged by removing the cars with import loads and shuttling to the RRBCY 113, FIG. 6, returning with well cars filled with export loads. This buffering process allows the ship and crane operation to continue without interruption by the rail operation.

FIG. 8 illustrates a conventional well car 49 or double stack car, both unloaded 53 and loaded 51. The double stack car or well car is specially designed for loading containers 55 two high. FIG. 9 depicts a plan view of an BMMT with ship 41 at pier, four container cranes 95 four magazines 121a, b, c, d with four rail lines 119 serving each magazine. Each magazine has an ITZ and each magazine is served by truck lanes from the ship to the magazine 117 and truck lanes returning to the ship 118. The direction of traffic for the export truck lane 118 and the import truck lane 117 of magazine 121 a is shown. All rail lines converge into a magazine to buffer corridor 88, FIG. 6, leading to the remote rail buffer and classification yard 113, FIG. 6, and to the dedicated freight corridor 89, FIG. 15. There is no cross-traffic required to maintain this pattern, which is an important safety consideration.

FIG. 10 depicts a plan view of an BMMT with ship 41 at pier 45, four container cranes 95 four magazines 121a, b, c, d with four rail lines 119 serving each magazine. Each magazine has an ITZ and each magazine is served by truck lanes from the ship to the magazine 117 and truck lanes returning to the ship 118. The direction of traffic for the export truck lane 118 and the import truck lane of magazine 121b is shown. All rail lines converge into a magazine to buffer corridor 88, FIG. 6, leading to the rail storage buffer and classification yard 113, FIG. 6, and to the dedicated freight corridor 89, FIG. 15.

FIG. 11 depicts a plan view of a magazine 121a containing four rail lines 119, an ITZ 79, import truck lane 117 and export truck lane 118. The magazine contains two rail mounted gantry cranes 99, and two ship cranes 95 adjacent to the pier 45. The drawing illustrates a view of the magazine before a ship or export loads have arrived.

FIG. 12 depicts a container ship 41 with hatches H1 and H3 having the stacked containers above the hatch covers removed first. This is an example. Two ship cranes 95 are deployed to work a pair of hatches separately, but working one magazine. Each pair of hatches being simultaneously unloaded has a hatch between them to allow for crane clearance. The drawing further depicts import containers from above the hatch 58 unloaded and transferred along the truck lane 117 to the empty well cars. After the import containers above the hatch 58 are unloaded, the hatch covers can be removed and the import containers below the hatch 56 can be unloaded. This example shows two rail mounted gantries 99 assisting the operations at the magazine. At this point in time, the export loads 48 are awaiting the clearance of a vertical cell before loading of the ship may commence. The export truck lane 118 is empty at this point in time.

Containers may be directed to specific well cars by preplan, stow on the go, via radio or via computer screen in the cab of the mobile transport. Unloading continues until well cars in a first magazine are filled.

At the magazine, export loads having been offloaded from the well cars into the ITZ, are transferred to the ship while import loads from deck stow 58 are transferred to the empty well cars via, for example, bomb carts and tractors, and mobile lifts such as reach stackers.

As the magazine fills, hatch covers HI and H3 start to clear. Hatch covers are removed and unloading of below deck cells begins. Once a vertical cell has been cleared below deck, the simultaneous load and discharge (“SLD”) process begins on the ship, including loading of outbound export containers and continued unloading of import containers.

FIG. 13 illustrates a top down view of an BMMT 83 at a point in time when the container ship 41 is in the process of simultaneous loading and discharge (“SLD”). Two ship cranes 95 are deployed to work a pair of hatches separately, but working one magazine. The unloading of import loads from below the hatch cover 56 continues at hatches HI and H3, creating cleared vertical cells. Now, export loads 48, which had been located in the ITZ 79 can begin to be loaded onto the ship 41 via the export truck lane 118 and placed below the hatch covers, while simultaneously continuing the unloading of import loads 56, 58 arriving via the import truck lane 117. When the first set of hatches have been completed, the cranes may be moved, and a different magazine may be used to start the above described cycle with different hatches. This example shows two rail mounted gantries 99 assisting the operations at the magazine.

At the magazine, this SLD continues until the well cars in the magazine are full of import loads. At that point, these loaded well cars with import loads are shuttled out along the rail lines 119 from the rail magazine to the RRBCY 113, FIG. 6. The SLD operation continues at a second magazine. Starting with a well car loaded with export containers, these export containers are then unloaded. When a well car is fully unloaded, it is then loaded with import containers as the remaining export containers continue to be unloaded. The SLD process continues until rail cars are fully loaded with import containers.

FIG. 14 illustrates a top down view of the rail magazine at a point in time when the transfers involving hatches H1 and H3 are complete, and are fully loaded with export loads 48. The ship cranes have moved to hatches H2 and H4 to continue in this magazine, the cycle outlined in the description of FIGS. 12 and 13. The drawing illustrates import loads 63 from the ship 41 using ship cranes 95, being moved to the rail cars along the import truck lane 117. At this point, the export loads 48 are located in the ITZ 79 awaiting a cleared vertical cell. The export truck lane 118 is shown empty. This example shows two rail mounted gantries 99 assisting the operations at the magazine.

SLD continues until all import loads on the ship have been discharged and replaced with export containers. When SLD is complete, the hatch covers are replaced and a one-way load process may begin above the hatch covers. When the loading is complete, the ship departs, leaving a clean terminal with no containers that is immediately ready for the next ship. FIG. 15 depicts a Buffered Marine Magazine Terminal (“BMMT”) 83 as part of a Buffered Marine Terminal Agile Port System consisting of the BMMT 83, a Remote Rail Buffer and Classification Yard (“RRBCY”) 113, tracks connecting the two 88, a Dedicated Freight Corridor (“DFC”) 89, and an Intermodal Interface Center (“IIC”) 91. The IIC connects to the Intermodal World 125 and possibly to other marine terminals via a dedicated access corridor 85.

### 5. DESCRIPTION OF PREFERRED EMBODIMENTS

In FIG. 1, consider the following example of the above operation. At the start of operations, a container ship 41 arrives full of import cargo, including containers 58 stored in the on-deck stow and containers 56 stored in the below deck stow. There are some export containers 47, 48 on well cars 49.

The on-deck stow 58 is cleared with the crane 95, onto the pier 45. Each container 63 is picked up by the mobile lift 97, 105 from the pier 45 and transported to the rail magazine 121, where it is placed in a well car 49, 53. Meanwhile, export containers 47, 48 are removed from the well car 49 and placed in the ITZ 79. This process is repeated until the on-deck stow 58 is clear, hatch covers 65 have been removed, below deck containers 56 have been removed, and there is a cleared vertical cell 77. The containers that were in the on-deck stow 58 of the container ship 41 are now on the well cars 49. The export containers that were on the well cars 49 are now in the ITZ 79 or still loaded in well cars 53.

Thus, the operation as thus far described begins with a one-way discharge of import containers 58 from the container ship 41 and a simultaneous discharge and load of well cars 49 destined for the ITZ 79. Export containers 47, 48 are removed from a well car 49 and immediately replaced with import containers 56, 58, 63 just discharged from the container ship 41.

The ship maintains a discharge only operation until the on-deck stow 58 has been cleared, the hatch covers 65 removed, and a cleared vertical cell 77 has been created (FIG. 2). At this point, an inventory of ITZ 79, FIG. 5 containers 48, FIG. 5 for export is accumulated in the ITZ 79, the number of these containers being approximately equal to the number of containers from the container ship 41 that have been discharged.

The process continues as follows. Containers 56 and 58 continue to be taken from the container ship 41 by the crane 95, placed on the pier 45, and transported by the mobile lift 97, 105 to the rail magazine 121 where each import container is loaded onto a well car 49, 51, 53. The export containers 47 and 48 (FIG. 5) or 47 (FIG. 1) from the well cars 49 are transported by another mobile lift 97, 105 to either the container ship 41 or the ITZ 79. Whether the container is taken directly to the ship 41 or the ITZ 79 depends on the container's attributes, keeping in mind that containers should be loaded on the ship 41 as customarily determined by their attributes. Attributes considered may include destination, weight, hazardous materials, temperature-controlled cargo, and container size.

The selection of containers 55 to be loaded onto the well cars 49 and thence to the train is accomplished in a different way. Ideally, only short blocks of well cars 49 would be unloaded/loaded at the rail magazine 121. The container ship 41 was loaded at its origin to ensure that containers for priority destinations are concentrated in the on-deck stow 58 and in the vertical cell 73 which will become the first cleared vertical cell 77. As the initial well cars 49 are loaded with import loads, they can be shuttled to a RRBCY 113 where they can be combined with other rail cars until sufficient cars have been accumulated to form a train that is destination specific or sent to the IIC 91. At the IIC 91, the rail cars from the BMMT could combine with cars with containers from other container ships or rail cars containing containers with domestic cargo.

Once the container ship 4t commences this simultaneous load and discharge mode, an export container 47 can be loaded onto the container ship 41 as a new import container 63 is discharged from the container ship 41. Specifically, the crane 95 discharges an import container 63 from a next vertical cell 73 to be cleared onto the pier 45. The mobile lift 97, 105 has, meanwhile, placed an export container on the pier 45. Then, the crane 95 loads the export container into the cleared vertical cell 77.

Export containers 47, 48 can be loaded directly from the well car 49 into the container ship 41 or the ITZ 48. If the container 47, 48 does not have the proper attributes to be loaded at the time, it may be stored in the ITZ 79, and replaced with an ITZ container 48 that does meet the loading requirements at the time, and thus be loaded onto the container ship 41. This particular stowing protocol can be maintained without any increase in the inventory of ITZ containers 48 contained within the ITZ 79, as one replaces the other.

The simultaneous load and discharge process continues until all of the import containers 56, 58, 63 have been discharged from the particular hatch. The container ship 41 now commences a load only operation until the last vertical cell 73 is filled, the hatch covers 65 replaced, and the on-deck stow 58 is loaded with export containers.

The integrated simultaneous load and discharge of both the container ship 41 and the train can be maintained indefinitely as long as well cars 49 in rail magazines 121 are supplied and removed “just in time” to maintain the operation. The significance is that a ship of any size can be worked without a further increase in the size of the yard, assuming the same number of cranes are used. It would take longer to work a larger ship than a smaller ship, but would not require any more land for the operation.

The only containers required to be inventoried on a dock at the site is that number of export containers discharged from the train that could not be loaded onto the container ship, until the container ship 41 could institute a SLD mode of operation. The largest known ships today would require an inventory of a maximum of 105 containers for the largest hatches. It is anticipated that this number may increase in the future. The inventory of ITZ containers 48 is required to be maintained in the ITZ 79 only during the time those hatches are actually being worked. The recommended maximum inventory in the ITZ 79 of a rail magazine 121 at any given time is therefore the sum of the number of containers in the on-deck stow of the hatch and the number of containers needed to clear one of the largest vertical cells, which is a requirement to institute an SLD operation.

Once the first two containers 47 have been discharged from a well car 49, a simultaneous load and discharge operation can be commenced until the final two export containers 47 have been discharged and the final import containers 63 loaded onto the well cars 49.

The container ship 41 will maintain its SLD operation of each hatch until all import containers 56, 58 have been discharged. At this point, the process will convert to a load only operation until all the remaining export containers 47, 48, have been loaded. The final containers loaded onto the container ship will come from containers in the ITZ 79, FIG. 5. At this stage, the last of the well cars 49 will have been loaded and have departed, and the train operations will have terminated, thus leaving the dock clear of containers 55. Thereafter, the rail magazine can be used by another container ship immediately, thus greatly increasing the efficient use of space. The efficiency of the invention thus described is dependent on whether well cars containing containers for a specific container ship are supplied to and removed from the appropriate magazine just in time to maintain the balance of the system.

As shown in FIG. 15, the Buffered Marine Magazine Terminal (“BMMT”) 83 is part of a Buffered Marine Terminal Agile Port System consisting of the BMMT 83, a Remote Rail Buffer and Classification Yard (“RRBCY”) 113, tracks connecting the two 88, a Dedicated Freight Corridor (“DFC”) 89, and an Intermodal Interface Center (“IIC”) 91. The IIC connects to the Intermodal World 125 and possibly to other marine terminals via the dedicated access corridor 85. The system best uses electronic data management capability with participation by all users and a manager to assign priorities as required.

The IIC should be strategically located at the best possible interface between rail, highway, and air transportation systems and where land is more readily available than near the ports and cities. It is expected that it can be anywhere from close to the port to 150 or more miles away from the BMMT 83.

Trains that originate in the interior of the country with both domestic and export containers destined for local consignees or various ships and ship operators could terminate at the IIC. Rail cars with containers for specific ships could be assembled into short blocks of well cars that would be held and dispatched via the rail corridor 89 to the RRBCY 113 at the BMMT 83 and thence on demand to a specific magazine 121 adjacent to the ship 41. Containers for the local market would be delivered from the IIC or transferred from the well cars to chassis for truck delivery. Blocks of well cars containing import containers intended for interior destinations would be dispatched from the RRBCY 113 to the IIC 91 where they would be combined with cars containing domestic or import cargo from other sources into trains for specific destinations.

Typically cities have developed around ports and the industrial complex required to serve the city on the inland side of the city. Thus import or export containers for the local market have traditionally been delivered from or received at the port passing through the city, causing congestion and other environmental concerns.

One of the advantages of this invention is to reduce or eliminate the need to store containers on the Marine Terminals. This invention would also allow the direct delivery of import containers to the industrial complex without the need to enter the city. Export containers from the industrial complex could be first taken to the IIC and then to the port complex via the dedicated corridor. This approach would largely remove the need to store containers, import or export, at the Marine Terminals and would reduce congestion and other environmental concerns.

Trains that originate in the interior of the country with export containers destined for various ships and ship operators could terminate at the IIC 91. Rail cars with containers for specific ships would be assembled into blocks of well cars that would be held in the IIC 91 and dispatched via the DFC 89 to the RRBCY 113 and thence the container ship 41 on demand. On the one hand, containers for local delivery are unloaded from the rail cars and held in a storage area in the IIC 91 until delivery can be accomplished. On the other hand, locally originating containers are received, loaded onto cars, and consolidated into trains as required. Blocks of cars dispatched from the IIC 91 along the corridors 88, 89 to a container ship 41 undergo the process described above and return to the IIC 91 with other containers. These containers could either be for local delivery or for movement to an interior destination. As described above, the containers are sorted, so that containers for local delivery are unloaded and held until delivery can be accomplished, whereas cars with containers for inland destinations are matched with other cars until a train is assembled and dispatched.

The work done at the IIC includes breaking down trains with cargo for export so that short blocks of cars with containers for specific container ships are dispatched via the DFC 89 to the RRBCY 113 and held until needed by the ship (FIG. 15). The work to be done also consists of receiving, via the DFC 89, rail cars of containers from the various container ships destined to numerous inland locations and reworking or reassembling these cars to make up trains to be dispatched to these locations.

The mobile lifts that are illustrated in the figures are mechanical types of devices for picking up containers. These mobile lifts include straddle carriers, such as illustrated in the figures. Also available are top picks, side picks, smaller gantries, rubber tired gantry cranes, rail-mounted gantry cranes, etcetera. Thus, “mobile lift” is used herein as a generic term for this mechanical device that lifts and/or transports a container from one point to another.

Reference is made back to FIG. 15. The DFC 89 is ideally a grade separated corridor from the RRBCY 113, through the existing city, to an IIC 91. Thereby, rail cars can be shuttled without interference to or by local road traffic. As an alternative, if a full train can be assembled in the BMMT 83, it can be moved together to the IIC 91 or direct to its ultimate destination. A major advantage of this invention is a reduction in highway traffic congestion, air and noise pollution close to major population centers. The IIC 91 could therefore be located, for example, many miles away from the ship.

While specific embodiments of the invention have been described and illustrated, it is clear that variations in the details of the embodiments specifically illustrated and described may be made without departing from the true spirit and scope of the invention as defined in the appended claims.

What is claimed is:

1. A method of unloading containers from a ship without hatch covers to land transports using a buffered rail magazine system, the method comprising the steps of:
a. charging a first magazine by placing empty rail cars into the first magazine;
b. charging a second magazine by placing empty rail cars into the second magazine;
c. discharging containers from the ship into the empty rail cars in the first magazine until all rail cars in the first magazine are full;
d. switching to the second magazine and continuing the ship unloading operation in the second magazine;
e. switching out loaded rail cars filled with import loads from the first magazine;
f. recharging the first magazine by switching in empty rail cars;
g. repeating the ship unloading operation in the second magazine until the rail cars in the second magazine are full of import loads;
h. switching the ship unloading operation to the first magazine and continuing the ship unloading operation into the first magazine;
i. repeating the above operations until the last container to be discharged has been removed from the ship.

2. A method of loading containers into a ship without hatch covers from land transports using a buffered rail magazine system, the method comprising the steps of:
a. charging a first magazine by placing rail cars loaded with export loads into the first magazine;
b. charging a second magazine by placing rail cars loaded with export loads into the second magazine;
c. loading containers into the ship from the rail cars in the first magazine until all rail cars in the first magazine are empty;
d. switching to the second magazine and continuing to load containers into the ship from the rail cars in the second magazine;
e. switching out the empty rail cars from the first magazine; f recharging the first magazine with rail cars loaded with export loads;
g. continuing the ship loading operation in the second magazine until the rail cars in the second magazine are empty;
h. switching the loading operation to the first magazine and continuing the ship loading operation from the first magazine;
i. repeating the above operations until the last container has been loaded onto the ship;

3. A method of unloading and loading containers from and to a ship without hatch covers to and from land transports using a buffered rail magazine system, the method comprising the steps of:
a. charging a first magazine by placing rail cars into the first magazine, wherein there are sufficient empty slots to accommodate the number of containers in the largest cell of the hatch of the ship being worked, and wherein the balance of the cars in the magazine contain export loads;
b. charging a second magazine by placing rail cars loaded with export loads into the second magazine;
c. discharging containers from the ship into the empty slots of the rail cars in the first magazine until the deepest cell of the hatch has been emptied;
d. taking an export container from the rail car in the first magazine and loading it onto the ship, into the just emptied cell in the ship's hatch;
e. taking an import container from another cell and loading that container into an empty slot on the train;
f. repeating the simultaneous load and unload operation until the first magazine is full of import loads and all of the exports from first magazine have been loaded onto the ship;
g. moving the simultaneous load and unload operation to the second magazine;
h. continuing the simultaneous load and discharge operation on the second magazine;
i. switching out the rail cars loaded with import loads from the first magazine;
j. recharging the first magazine by switching in rail cars filled with export loads;
k. repeating the simultaneous load and unload operation in the second magazine until the second magazine is full of import loads and all of the export loads from second magazine have been loaded onto the ship;
l. moving the simultaneous load and unload operation to the first magazine;
m. repeating the above operations until the last load of the hatch has been removed;
n. commencing a one-way ship load operation until the last export load has been placed into the hatch;
o. repeating the above operations for each hatch of the ship until the ship has been unloaded of import loads and loaded with export loads.

4. A method of unloading containers from a ship with hatch covers to land transports using a buffered rail magazine system, the method comprising the steps of:
a. charging a first magazine by placing empty rail cars into the first magazine;
b. discharging containers from the ship onto the rail cars in the first magazine;
c. charging a second magazine by placing empty rail cars into the second magazine;
d. switching out the rail cars from the first magazine when they are all loaded;
e. discharging containers from the ship onto the rail cars in the second magazine;
f. charging the first magazine by placing empty rail cars into the first magazine;
g. removing the rail cars from the second magazine when they are all loaded;
h. repeat above steps b through g until the hatch is fully unloaded.

5. A method of loading containers onto a ship with hatch covers from land transports using a buffered rail magazine system, the method comprising the steps of:
a. charging a first magazine by placing full rail cars into the first magazine;
b. loading containers from the rail cars in the first magazine onto the ship;
c. charging a second magazine by placing full rail cars into the second magazine;
d. removing the rail cars from the first magazine when they are fully unloaded;
e. loading containers from the rail cars in the second magazine onto the ship;
f. charging the first magazine by placing full rail cars into the first magazine;
g. removing the rail cars from the second magazine when they are fully unloaded;
h. repeat above steps b through g until the ship is fully loaded.

6. A method of exchanging containers between a ship with hatch covers and land transports using a buffered rail magazine system, the method comprising the steps of:
a. placing empty rail cars into a first magazine sufficient in number to allow the unloading of one cell of the ship;
b. discharging containers from one cell of the ship onto the rail cars in the first magazine;
c. placing full rail cars full of export loads into the second magazine;
d. removing the rail cars from the first magazine when they are fully loaded with import loads;
e. discharging containers from a next cell of the ship onto the rail cars in the second magazine while simultaneously loading containers from the second magazine into the first cell of the ship;
f. charging the first magazine by placing full rail cars into the magazine;
g. removing the rail cars from the second magazine when they are all loaded with containers from the ship;
h. repeat above steps b through g until the hatch is fully loaded.

7. A method of exchanging containers between a ship and land transports using a buffered rail magazine system, the method comprising the steps of:
a. placing full rail cars into a first magazine sufficient in number to allow the unloading of one cell of the ship;
b. unloading all the rail cars in the first magazine into an intermodal transition zone;
c. discharging containers from one hatch of the ship onto the rail cars in the first magazine;
d. placing full rail cars into the second magazine;
e. removing the rail cars from the first magazine when they are all loaded with import containers;
f. loading containers from the second magazine into the first cell of the ship while simultaneously discharging containers from a next cell of the ship onto the rail cars of the second magazine;
g. charging the first magazine by placing rail cars loaded with export loads into the magazine;
h. removing the rail cars from the second magazine when they are all loaded with import containers from the ship;
i. repeat above steps c through h until the ship is fully unloaded.
j. load the containers contained in the intermodal transition zone of the first magazine into a cell on the ship. OR: commence a load only operation until the last vertical cell is filled, the hatch covers, if any, are replaced, and the on-deck stow, if any, is loaded with export containers

8. A method of exchanging containers between a ship and land transports using a buffered rail magazine system, the method comprising the steps of:
a. placing full rail cars into a first magazine sufficient in number to allow the unloading of one vertical stack of containers from the ship;
b. unloading all the rail cars in the first magazine into an intermodal transition zone;
c. discharging containers from one vertical stack of the ship onto the rail cars in the first magazine;
d. placing full rail cars into the second magazine;
e. removing the rail cars from the first magazine when they are all loaded;
f. loading containers from the second magazine into the space formerly occupied by the first vertical stack of the hatch and discharging containers from a next vertical stack of the hatch onto the rail cars in the second magazine simultaneously;
g. charging the first magazine by placing full rail cars into the magazine;
h. removing the rail cars from the second magazine when they are all loaded with containers from the ship;
i. repeat above steps c through h until the hatch is fully unloaded;
j. load the containers contained in the intermodal transition zone of the first magazine into a cell on the ship;
k. replace the hatch covers;
l. load and stow the remaining containers onto the hatch covers.

9. The method of exchanging containers between a ship and land transports using a buffered rail magazine system as in claim 7 or 8, the method further comprising the steps of:
a. placing the containers into the intermodal transition zone using precisely located hard points and crane automation.

10. The methods of exchanging, loading, and unloading containers between a ship and land transports using a buffered rail magazine system as in any one of claims 1 through 8, the methods further comprising the step of:
a. transferring the containers between the ship and the rail cars using separate ship and rail cranes interconnected by intermediate ground transport.

11. The methods of exchanging, loading, and unloading containers between a ship and land transports using a buffered rail magazine system as in claim 10, the method further comprising the steps of:
a. using multiple cranes on a second side of a ship in a slip berth;
b. duplicating the magazine exchange, loading, or unloading steps for the cranes on the second side of the ship to its own set of rail magazines.

12. The methods of exchanging, loading, and unloading containers between a ship and land transports using a buffered rail magazine system as in claim 10, the method further comprising the steps of:
a. using cranes that span the width of the ship allowing transfer of containers to either side of the slip;
b. duplicating the magazine exchange, loading, or unloading steps for the cranes on the second side of the ship to another set of rail magazines.

13. The method for exchanging containers between a ship and land transports as in claims 7 or 8, the method further comprising the steps of:
a. transferring loaded well cars out of the magazine area into a remote rail buffer and classification yard.

14. The method for exchanging containers between a ship and land transports as in claim 12, the method further comprising the steps of:
a. collecting and consolidating the loaded well cars in an intermodal interface center.

15. The method for exchanging containers between a ship and land transports as in claim 14, the method further comprising the steps of:
a. utilizing an electronic data processing capability to track the containers in a data management system.

16. The method for exchanging containers between a ship and land transports as in claim 10, the method further comprising the steps of:
a. transporting the containers via mobile lifts such as straddle carriers between the ship and the rail cars in the magazine.

17. The method for exchanging containers between a ship and land transports as in claim 10, the method further comprising the steps of:
a. transporting the containers via mobile lifts such as fork lifts between the ship and the rail cars in the magazine.

18. The method for exchanging containers between a ship and land transports as in claim 10, the method further comprising the steps of:
a. transporting the containers between the ship and the rail cars in the magazine using prime movers with tractors, bomb carts.

19. The method for exchanging containers between a ship and land transports as in claim 10, the method further comprising the steps of:
a. transporting the containers between the ship and the rail cars in the magazine using reach stackers.

20. The method for exchanging containers between a ship and land transports as in claim 10, the method further comprising the steps of:
a. transporting the containers between the ship and the rail cars in the magazine using prime movers with bomb carts or chassis;
b. loading and unloading the rail cars in the magazines from an to the bomb carts or chassis using gantry cranes.

21. The method for exchanging containers between a ship and land transports as in claim 10, the method further comprising the steps of:
a. using a circular routing for intermediate ground transport so as to avoid cross-traffic.

22. A buffered rail magazine system, the system comprising:
a. a wharf to accommodate a ship;
b. at least two cranes to load and unload the ship;
c. one rail magazine for each crane, each rail magazine comprising a grouping of multiple closely placed parallel rail tracks adjacent to the crane;
d. each magazine oriented perpendicular to the length of the ship,
e. the rail magazines connected to a rail transportation system generally used for shipping.

23. The buffered rail magazine system of claim 22, further comprising:
a. a set of intermediate ground transports with a circular route for transporting the containers from the ship crane to a train crane;
b. the magazine train crane for loading and unloading trains to and from the intermediate ground transports.

24. The buffered rail magazine system of claim 22 or 23, further comprising:
a. an area adjacent to the grouping of parallel rails in each rail magazine for temporary container storage sufficient to hold the containers until the simultaneous load and discharge operation can commence.

25. The buffered rail magazine system of claim 22 or 23, further comprising:
a. precisely located hard points in the intermodal transition zone enabling automation of container placement.

26. The buffered rail magazine system of claim 22 or 23, further comprising:
a. a remote rail buffer and classification yard for organizing and storing the rail cars to be placed into each magazine.

27. The buffered rail magazine system of claim 26, further comprising:
a. a dedicated freight corridor between the remote rail buffer and classification yard and the magazines.

28. The buffered rail magazine system of claim 22 or 23, further comprising:
a. a second wharf located on the opposite side of the ship from the first wharf to form a slip berth;
b. The cranes and accompanying magazines placed on the wharves on both sides of the ship.

29. The buffered rail magazine system of claim 22 or 23, further comprising:
a. a second wharf located on the opposite side of the ship from the first wharf to form a slip berth;
b. The cranes spanning the ship;
c. accompanying magazines placed on the wharves on both sides of the ship.

30. The buffered rail magazine system of claim 23, further comprising:
a. straddle carriers as the intermediate ground transports.

31. The buffered rail magazine system of claim 23, further comprising:
a. prime movers and bomb carts as the intermediate ground transports.

32. The buffered rail magazine system of claim 23, further comprising:
a. prime movers and container chassis as the intermediate ground transports.

33. The buffered rail magazine system of claim 23, further comprising:
a. reach stackers as the intermediate ground transports.
